(19) United States
(12) Patent Application Publication
(10) Pub. No.: US 2003/0161399 A1
(43) Pub. Date: Aug. 28, 2003

(54) Multi-layer composite objective image quality metric

(75) Inventor: Walid S.I. Ali, Ossinning, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/081,967

(22) Filed: Feb. 22, 2002

(51) Int. Cl. H04N 7/12

(52) U.S. Cl. 375/240.08; 375/240.16; 375/240.24

(57) ABSTRACT

A composite image is segmented into regions corresponding to different objects within the image based upon motion vectors for pixel blocks within the image. Each image segment is assigned an importance based on relative size of the region and average scalar value of motion vectors for pixel blocks within the region. Objective image quality values are computed for each region, and the products of importance indicators and objective image quality values for each segment are summed across all segments within the image to obtain an overall image quality.

### TECHNICAL FIELD OF THE INVENTION

The present invention is directed, in general, to image quality evaluation for video systems and, more specifically, to image quality metrics based on human perception of image quality.

### BACKGROUND OF THE INVENTION

Perceptual image quality for composite graphic or video images (i.e., either motion or still images depicting a plurality of objects) may generally be modeled as a multi-channel system, where masking or weighting models the manner in which human vision decomposes images into different image features. Such modeling corresponds to human multi-resolution vision capabilities, whereby images are judged by looking into different levels of information and the associated accosted details such as Weber fraction and visual masking. Human viewers judge each image component differently, then re-combine the components again to give an overall value of the picture quality.

Proposed objective image quality metrics for composite images provide an overall quality measure for a entire image without mimicking the component-based manner in which human vision judges an image, and are therefore not completely satisfactory. For example, a noisy, still background is far less annoying to a human viewer than a blocky human face whose details are completely or nearly completely lost.

There is, therefore, a need in the art for an a objective image quality metric for composite images that is keyed to human perception of image quality.

### SUMMARY OF THE INVENTION

To address the above-discussed deficiencies of the prior art, it is a primary object of the present invention to provide, for use in a video system, an image quality evaluation algorithm in which a composite image is segmented into regions corresponding to different objects within the image based upon motion vectors for pixel blocks within the image. Each image segment is assigned an importance based on relative size of the region and average scalar value of motion vectors for pixel blocks within the region. Objective image quality values are computed for each region, and the products of importance indicators and objective image quality values for each segment are summed across all segments within the image to obtain an overall image quality.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a video system generating an objective image quality metric for composite images according to one embodiment of the present invention;

FIGS. 2A-2B are illustrations of a composite image for which an objective image quality metric is computed according to one embodiment of the present invention; and

FIG. 3 is a high level flowchart for a process of computing an objective image quality metric according to one embodiment of the present invention.

### DETAILED DESCRIPTION OF THE INVENTION

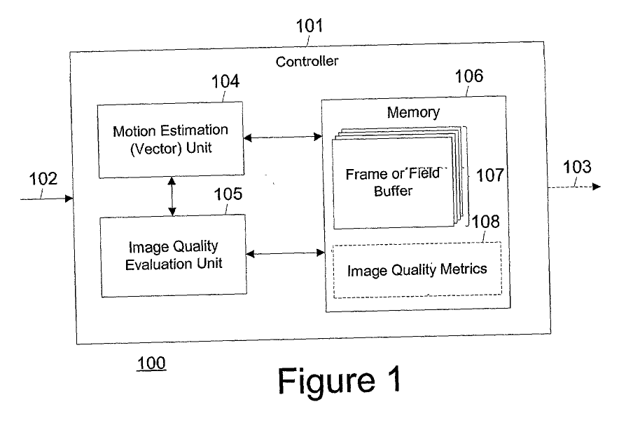

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a video system generating an objective image quality metric for composite images according to one embodiment of the present invention. Video system 100 includes a controller 101 having an input 102 for receiving video information. Input 102 may be an input to the video system 100 for receiving video information from an external source via a decoder (not shown), or may alternatively be simply a connection to another component within video system 100 such as a disk drive and decoder. Controller 101 may optionally also include an output 103 coupling video system 100 to an external device and/or coupling controller 101 to a recording device such as a hard disk drive.

Video system 100, in the present invention, may be any of a wide variety of video systems including, without limitation, a satellite, terrestrial or cable broadcast receiver (television) , a personal video recorder such as a video cassette recorder (VCR) or digital video recorder, a digital versatile disc (DVD) player, or some combination thereof. Video system 100 may alternatively be a system designed and employed for evaluating generating video content, for converting video content from one form to another (e.g., analog or film to digital video), or for simply evaluating video content and/or the performance of another video device.

Regardless of the particular implementation, controller 101 within video system 100 includes a motion estimation unit 104 and an image quality evaluation unit 105, the functions of which are described in further detail below. Controller 101 may also include a memory or storage 106 structured to include a frame or field buffer 107 for storing receiving video information and optionally also an 20 image quality metric(s) table 108 containing objective image quality metrics for evaluated fields or frames.

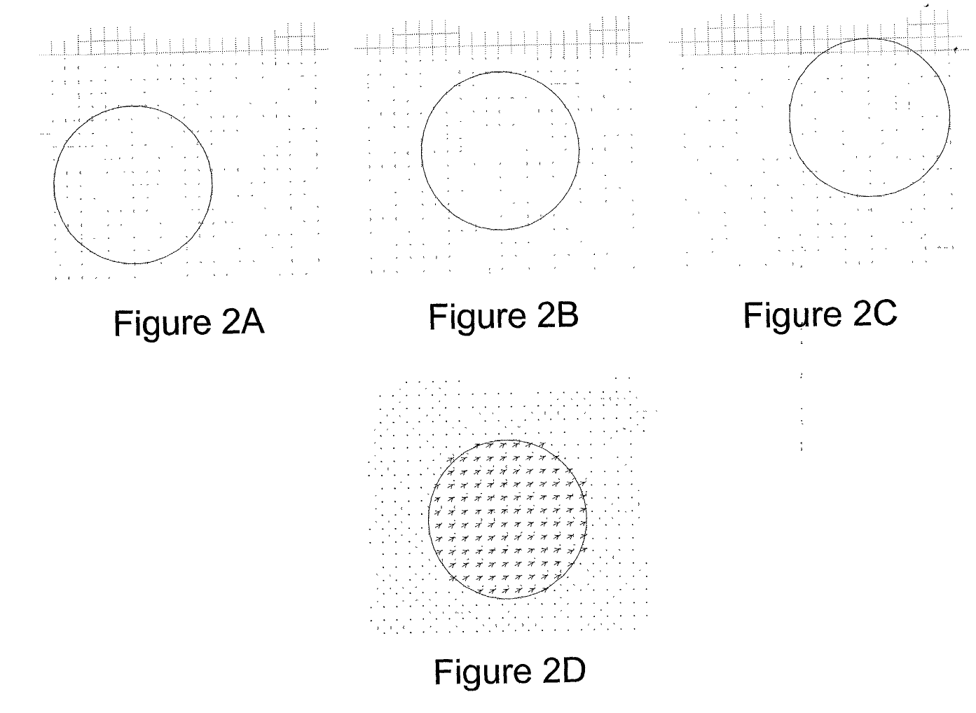

FIGS. 2A through 2D are illustrations of a composite image for which an objective image quality metric is computed according to one embodiment of the present invention, and are intended to be considered in conjunction with FIG. 1. FIGS. 2A through 2C depict an arbitrary portion of each of three consecutive fields or frames from a video sequence, in which an object (a circle in the example shown) moves from lower left to upper right across a stationary background.

In deriving an objective image quality metric for one of the images (FIG. 2B), motion vectors for blocks of pixels indicated by the grid lines are calculated within motion estimation unit 104 in accordance with the known art. Such motion estimation is often performed for motion compensation during field rate conversion or similar tasks, and typically employs blocks of, for instance, 4×4 pixels, although any arbitrary size block (including single pixels) may be employed. The resulting set of motion vectors for the blocks within the image portion of FIG. 2B are graphically illustrated in FIG. 2D, in which the dots indicate no motion and the arrows indicate a direction and scale of motion for the associated pixel blocks. In the present invention, controller 101 segments each received image based on the motion vectors produced by motion estimation unit 104. Contiguous blocks having similar motion vectors are considered to represent an object, and adjacent blocks having disparate motion vectors are presumed to represent the boundaries of an object. In this manner, different objects within a composite image may be identified. The objects of interest may be limited to “significant” objects, or objects of at least a threshold size. The simplistic image of FIG. 2B, for example, includes only two objects (the circle and the background) both of which may be considered significant, although more realistic composite video images may depict numerous objects of varying degrees of significance.

To derive an objective image quality metric for a composite image, controller 101 segments the image into different regions corresponding generally, but not necessarily precisely, to the different significant objects identified within the image from the motion vectors. Each significant object, or the region associated therewith, is assigned an importance indicator N which may be, for example, simply a product of (a) the relative size of the object or region with respect to the overall image times (b) an average of the estimated motion vectors associated with the object or region. Objects with a higher importance indicator are assumed to be of basically greater interest to the viewer, and therefore of greater effect on perceived image quality. Thus, for example, separate importance indicators would be assigned to the circle and the background within the image of FIG. 2B.

An objective image quality O is then derived by image quality evaluation unit 105 for each significant object or region within the composite image selected for independent consideration by controller 101. Any suitable technique for evaluating image quality may be employed, including those disclosed in commonly assigned, co-pending U.S. patent application Ser. No. 09/734,823 entitled “SCALABLE DYNAMIC OBJECTIVE METRIC FOR AUTOMATIC VIDEO QUALITY EVALUATION” filed Dec. 12, 2000, the content of which is hereby incorporated by reference. In the example of FIG. 2B, objective image quality values would be derived separately for the circle and the background.

The overall image quality OIQ for a composite image is then computed from the sum of products of each object's (or region's) objective image quality value Oᵢ and the assigned importance indicator Nᵢ for that object (or region):

$$OIQ = {\sum }_{i = 1}^{m} {O}_{i} {N}_{i} ,$$

where m is the total number of significant objects (or regions) within the composite image.

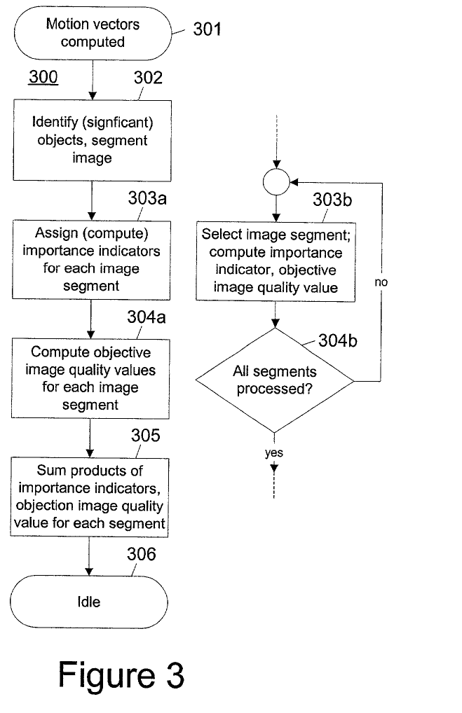

FIG. 3 is a high level flowchart for a process of computing an objective image quality metric according to one embodiment of the present invention. The process 300, executed within controller 101 depicted in FIG. 1 in the exemplary embodiment, begins with receipt of image data for a subject image (and, as necessary, sequential images within a video segment) and/or computation within motion estimation unit 104 of a set of motion vectors for an image (step 301), although alternatively the requisite motion vectors may be received also from a source external to controller 101.

The motion vectors for the image are employed by controller 101 to identify different objects within the received image data, and the image is segmented into regions corresponding to the identified objects (step 302). While all objects of any size may be identified and independently treated, preferably the image is segmented into regions corresponding only to significant objects of at least a threshold size (number of pixels or blocks of pixels) within the composite image.

Importance indicators are then assigned to each image segment (step 303a). In the exemplary embodiment, the assigned importance indicators are computed from the segments size relative to the entire composite image size (e.g., number or percentage of pixels or pixel blocks within the segment) and an average of scalar value of the motion vectors for blocks within the segment as described above. Objective image quality values are then computed for each segment (step 304a).

In an alternative embodiment, the importance indicator and objective image quality value may be determined for each segment in turn, with a segment being selected for such purpose (step 303b) and the process repeated iteratively until all segments have been selected and processed (step 304b).

Once the importance indicators and objective image quality values have been computed, the product of the associated importance indicator and objective image quality value for each image segment is computed, and such products are summed over all image segments within the composite image (step 305). The value obtained is the overall image quality for the entire composite image. The process then becomes idle until another image is received or processing of a next image is initiated (step 306).

It should be noted that the process 300 and controller 101 may be employed simply to compute the overall image quality value from received image data, which is then transmitted to another device for use therein.

The present invention allows image quality for a composite image to be objective computed in a manner similarly to human perception of image quality, based upon different objects within the composite image. Existing motion estimation techniques are employed to identify objects within the composite image, such that the process of the present invention may be readily incorporated into existing video systems employing motion compensation between frames or fields of a video segment. The resulting image quality metric provides a more accurate indicator of image quality for composite images than existing image quality metrics.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A system for computing overall image quality for a composite image comprising:
a controller receiving image data for the composite image, the controller:
segmenting the image data into segments corresponding to different objects within the composite image,
computing an image quality value for each segment, and
deriving an overall image quality value from the image quality values for all segments within the composite image.

2. The system according to claim 1, wherein the controller, in segmenting the image data into segments corresponding to different objects within the composite image, employs motion vectors for pixels or pixel blocks within the image to identify the different objects.

3. The system according to claim 1, wherein the controller, in deriving an overall image quality value from the image quality values for all segments within the composite image, associates an importance indicator with each segment rating an effect of the corresponding segment on image quality for the composite image.

4. The system according to claim 3, wherein the overall image quality value is computed from the sum, for all segments within the image, of a product of the importance indicator for a segment and the image quality value for that segment.

5. The system according to claim 3, wherein the importance indicator for a segment is computed from a relative size of the segment with respect to the composite image and an average estimated motion vector value for that segment.

6. A video system comprising:
an input for receiving image data for a composite image;
a motion estimator computing motion vectors for pixels or pixel blocks within the composite image; and
a controller receiving the image data and the motion vectors for the composite image, the controller:
segmenting the image data into segments corresponding to different objects within the composite image,
computing an image quality value for each segment, and
deriving an overall image quality value from the image quality values for all segments within the composite image.

7. The video system according to claim 6, wherein the controller, in segmenting the image data into segments corresponding to different objects within the composite image, employs the motion vectors for pixels or pixel blocks within the composite image to identify the different objects.

8. The video system according to claim 6, wherein the controller, in deriving an overall image quality value from the image quality values for all segments within the composite image, associates an importance indicator with each segment rating an effect of the corresponding segment on image quality for the composite image.

9. The video system according to claim 8, wherein the overall image quality value is computed from the sum, for all segments within the image, of a product of the importance indicator for a segment and the image quality value for that segment.

10. The system according to claim 8, wherein the importance indicator for a segment is computed from a relative size of the segment with respect to the composite image and an average estimated motion vector value for that segment.

11. A method of computing overall image quality for a composite image comprising:
segmenting image data for the composite image into segments corresponding to different objects within the composite image;
computing an image quality value for each segment; and
deriving an overall image quality value from the image quality values for all segments within the composite image.

12. The method according to claim 11, wherein the step of segmenting the image data into segments corresponding to different objects within the composite image further comprises:
employing motion vectors for pixels or pixel blocks within the image to identify the different objects.

13. The method according to claim 11, wherein the step of deriving an overall image quality value from the image quality values for all segments within the composite image further comprises:
associating an importance indicator with each segment rating an effect of the corresponding segment on image quality for the composite image.

14. The method according to claim 13, further comprising:
computing the overall image quality value from the sum, for all segments within the image, of a product of the importance indicator for a segment and the image quality value for that segment.

15. The method according to claim 13, further comprising:
computing the importance indicator for a segment from a relative size of the segment with respect to the composite image and an average estimated motion vector value for that segment.

16. A signal relating to overall image quality for a composite image comprising:
an overall image quality value for the composite image derived from image quality values for all segments of image data for the composite image,
wherein each image data segment corresponds to a different object within the composite image and image quality values are independently computed for all segments within the image data.

17. The signal according to claim 16, wherein the segments are based on motion vectors for pixels or pixel within the image.

18. The signal according to claim 16, wherein the overall image quality value is based on importance indicators associated with each segment and rating an effect of the corresponding segment on image quality for the composite image.

19. The signal according to claim 18, wherein the overall image quality value is computed from the sum, for all segments within the image, of a product of the importance indicator for a segment and the image quality value for that segment.

20. The signal according to claim 18, wherein the importance indicator for a segment is computed from a relative size of the segment with respect to the composite image and an average estimated motion vector value for that segment.
